(19) United States
(12) Patent Application Publication
(10) Pub. No.: US 2010/0235231 A1
(43) Pub. Date: Sep. 16, 2010

(54) LEAD ACQUISITION, PROMOTION AND INVENTORY MANAGEMENT SYSTEM AND METHOD

(75) Inventors: Christopher M. JEWER, Woburn, MA (US); Don J. MARZETTA, San Francisco, CA (US); Paul D. OSBORNE, Hudson, MA (US); John F. POTTER, Palo Alto, CA (US); Mark W. CORDEIRO, San Francisco, CA (US)

Correspondence Address: NIXON PEABODY LLP, 401 Ninth Street, N.W., Suite 900, WASHINGTON, DC, 20004, US

(73) Assignee: CBS INTERACTIVE, INC., San Francisco, CA (US)

(21) Appl. No.: 12/787,766

(22) Filed: May 26, 2010

Related U.S. Application Data
(63) Continuation-in-part of application No. 12/362,840, filed on Jan. 30, 2009.
(60) Provisional application No. 61/311,977, filed on Mar. 9, 2010.

(51) Int. Cl. G06Q 30/00

(52) U.S. Cl. 705/14.41; 705/14.66

(57) ABSTRACT

A lead acquisition, promotion and inventory management system and method are described that optimize the delivery and revenue of cost per acquisition (CPA) advertising programs, while implementing user targeting techniques to reach interested potential consumers. Clients, such as advertisers, can create a program to be implemented. Based on the program information, a number of leads is calculated that can be collected. The leads are generated by targeting and selecting qualified users from a user pool, and determining if they are compliant with the requirements of the program. Compliant leads are then allocated and delivered to the client.

### RELATED APPLICATION

This application is a continuation-in-part of U.S. patent application Ser. No. 12/362,840, filed Jan. 30, 2009, the disclosure of which is hereby incorporated by reference in its entirety. This application also claims the benefit of U.S. Provisional Application No. 61/311,977, filed Mar. 9, 2010, the disclosure of which is hereby incorporated by reference in its entirety.

### COPYRIGHT NOTICE

A portion of the disclosure of this patent document contains material which is subject to copyright protection. The copyright owner has not objected to the facsimile reproduction by anyone of the patent document or the patent disclosure, as it appears in the Patent and Trademark Office patent file or records, but otherwise reserves all copyright rights whatsoever.

### TECHNICAL FIELD

The present invention relates to a targeted advertising system and method. More particularly, the present application relates to a lead acquisition, promotion and inventory management system and method.

### BACKGROUND

Networks and interconnectivity of individuals, groups, and organizations have dramatically increased in recent years. The Internet connects the world by joining users that represent various entities, information, and resources. These connected users form enormous banks of resources, resulting in a world wide web of users. The users store and access data files, documents, and Web pages containing various content.

The growth of the Internet has created many opportunities for users to uncover content and other resources related to their interests Likewise, the growth has created opportunities for Web service providers to seek out users that may be interested in obtaining resources from the Web service provider, such as targeted advertisements. Users and providers communicate electronically, often exchanging resources and conducting electronic commerce. Web technology has made it possible to target information and resources to users with specific interests.

Targeting users with specific interests seeks to make the exchange of information and electronic commerce more efficient. Users receive materials related to their interests, while topics and materials in which they are not interested are sent to others. Targeting users seeks to reduce the burden on users who may ultimately consume products and services of the Web service providers. Targeting users helps alleviate the volumes and volumes of potential providers. To reduce the number of irrelevant product providers and to increase the quality of a consumer's interaction with relevant Web service providers, information regarding potential consumers may be filtered to deliver the most relevant materials to the user. Additionally, by properly targeting likely users, Web service providers may more efficiently focus their marketing and sales efforts.

Information filtering may be performed in a number of ways. For example, a customary consumer telephone directory of businesses, such as the Yellow Pages, filters product providers by geographic calling area. Further, Web Service Providers and Internet portals also classify information by categorizing Web pages by topics such as news, sports, entertainment, and the like. However, these broad subject areas are not always sufficient to locate information of interest to a consumer.

More sophisticated techniques for filtering products and services of interest to consumers may be employed by identifying information about the user. These methods may monitor and record a consumer's purchase behavior or other patterns of behavior. Information may be collected by means of surveys, questionnaires, opinion polls, and the like. These conventional techniques may be extrapolated to the networked world by means of inferential tracking programs, cookies, and other techniques designed to obtain consumer information with minimal consumer effort and minimal expenditure of provider resources.

Filtering methods serve to organize the array of information, goods, and services to assist the user by presenting materials that the user is more likely to be interested in, or by directing the user to materials that the user may find useful. Filtering attempts to sift through the vast stores of information while detecting and uncovering less conspicuous information that may be of interest to the user. Filtering methods attempt to locate items of meaningful information that would otherwise be obscured by the volume of irrelevant information vying for the attention of the user.

Information filtering may be directed to content-based filtering where keywords or key articles are examined and semantic and syntactic information are used to determine a user's interests. Additionally, expert systems may be utilized to “learn” a user's behavior patterns. For example, expert systems or intelligent software agents may note a user's actions in response to a variety of stimuli and then respond in the same manner when similar stimuli present in the future.

As expert systems grow, or as intelligent software agents expand to cover additional users or groups, the range and accuracy of the responses may be refined to increase the efficiency of the system. Collaboration among users or groups of like users results in increased accuracy with regard to predicting future user responses based upon past responses. Evaluating feedback of other similar users is effective in determining how a similar user will respond to similar stimuli. Users that agreed in the past will likely agree in the future. These collaborative filtering methods may use ratings for articles such as information, goods, services, and the like, to predict whether an article is relevant to a particular user.

Information may be transferred and stored on a consumer's computer by a Web server to monitor and record information related to a user's Web-related activities. The user's Web-related information may include information about product browsing, product selections, purchases made by the user at Web pages hosted by a Web server. The information stored by the inferential tracking programs is typically accessed and used by the Web server when the particular server or Web page is again accessed by the user computer. Cookies may be used by Web servers to identify users, to instruct the server to send a customized version of the requested Web page to the client computer, to submit account information for the user, and so forth. Explicit and implicit user information collection techniques may be used by Web-based providers of goods and services. In some instances, user information gathered by the servers is used to create personalized profiles for the users. The customized profiles are then used to summarize the user's activities at one or more Web pages associated with the server.

Current content advisory systems often focus on enhanced shopping carts to provide suggested additional products a user may purchase, while others have developed advisory systems to provide product recommendations based in part on a vendor payment to the Web-based provider to sort and move the vendor's product to the top of the list of recommended products or services.

Conventional content advisory systems focus on a point of sale event and only take into account a user's imminent product purchase and possibly prior purchases from the specific merchant. These prior systems do not cover all related digital content a user or users with similar activity patterns, may have acquired from a variety of sources.

Filtering methods based upon the content of the user's activities may be used to reach information, goods, and services for the user based upon correlations between the user's activities and the items. The filtering methods and customized profiles may then be used to recommend or suggest additional information, goods, and services in which the user may be interested.

These conventional systems may not utilize user profile information based on collected demographics, user ratings, editorial classifications, and behavioral data. Because they lack this additional data, typical advisory systems do not factor it into their recommendations.

The ability to accurately profile and target a user or a collection of similar users of a Web site is a difficult problem. Registration data, including demographic information, forms a component of this analysis, however, most users do not register or complete the registration form, and the data collected is not updated based on a user's current interests. Behavioral data gathered from a user's activity on a Web site can provide a more current indication of a user's interest, however, it is difficult to classify the documents or actions taken by a user unless the information is tagged or categorized based on its content and contextual meta-data.

With respect to advertising, systems for managing and optimizing traditional advertising programs sold on a cost per impression (CPM) or cost per click (CPC) basis are well developed. The majority of internet advertising programs are sold on a CPM basis. Managing these types of programs is simply a problem of ensuring that there is adequate inventory available to all of the programs sold. While the development of behavioral and contextual targeting has complicated inventory management, the methods of managing this inventory are also well developed.

Most of the remaining advertising is sold on a CPC basis. The management of CPC programs is more complicated than managing CPM, because both the budget assigned by the advertiser, and the amount of revenue delivered by each CPC advertising unit has to be optimized. This revenue optimization is done by matching the CPC advertisements to the search or content context and by actively monitoring clicks on advertising units, so that poor performing units are less visible while better performing units are more visible. Although there continue to be wide disparities between the performance of the various optimization systems, there has been a substantial amount of work already done towards the development of management and optimization systems.

However, solutions for the more difficult problems posed in managing and optimizing lead acquisition (CPA) advertising programs implementing user targeting are far less developed for a number of reasons. For example, in CPA programs, the publisher is only paid for actions, such as on-site registrations or downloads, that are performed by qualified users. This makes inventory management and projection significantly harder than CPM or CPC inventory management and projection.

Additionally, programs only run over a limited amount of time. Therefore, ensuring that the entire budgeted amount of leads is delivered is significantly more complicated than ensuring the same budgeted amount of CPM or CPC programs are delivered. Optimization of total revenue requires balancing the revenue yielded by a particular action with the difficulty of attracting qualified users to perform the required action. These calculations are significantly more difficult than those involved in optimizing the revenue from CPC advertising.

Further, fulfillment of lead programs requires the utilization of more varied methods of promotion than is required to fulfill CPM or CPC advertising programs. In particular, managing promotion placement across web sites and within targeted newsletter and custom e-mail deliveries for CPA programs is more difficult than the problems posed by managing CPM or CPC promotions across a content or search network.

### SUMMARY

Thus, there is a need in the art for a lead acquisition, promotion and inventory management system and method that addresses these problems by optimizing the delivery and revenue of lead acquisition (CPA) advertising programs, while implementing user targeting techniques to reach interested potential consumers.

One embodiment of the invention provides a lead acquisition advertising system and method. The method preferably comprises receiving information about a program from a client, determining a number of leads that can be collected based upon the program information, assigning a relative promotional weight to the program based on its calculated need, generating leads by targeting program content to candidate users, with channels, placements and priority based on the program's promotional weight and the users' profiles, selecting the program to offer based on the assigned relative promotional weight, and match with the user profile, wherein at least one user profile includes taxonomic nouns identified from a document a user accessed, determining compliance of the one or more leads with the program information, and if the leads are compliant, allocating the leads, and delivering the allocated leads to the client. The system preferably comprises modules configured to carry out the steps of the method.

Still other aspects, features and advantages of the present invention are readily apparent from the following detailed description, simply by illustrating a number of exemplary embodiments and implementations, including the best mode contemplated for carrying out the present invention. The present invention also is capable of other and different embodiments, and its several details can be modified in various respects, all without departing from the spirit and scope of the present invention. Accordingly, the drawings and descriptions are to be regarded as illustrative in nature, and not as restrictive.

### BRIEF DESCRIPTION OF THE DRAWINGS

FIG. 1 is a flowchart illustrating a method according to one embodiment.

FIG. 2 is a diagram illustrating a system for implementing the method according to one embodiment.

FIG. 3 is a screen shot of a client interface according to one embodiment.

FIGS. 4a-4d are screen shots of reports that can be run according to one embodiment.

FIGS. 5a-e are screen shots of alert and/or monitoring interfaces according to one embodiment.

FIG. 6 is a schematic diagram of a system architecture according to one embodiment.

FIG. 7 is a block diagram of another architecture for implementing the method according to one embodiment.

FIG. 8 is a schematic diagram of an exemplary computer system according to one embodiment.

### DETAILED DESCRIPTION

A lead acquisition and inventory management system and method is described. In the following description, for purposes of explanation, numerous specific details are set forth in order to provide a thorough understanding of the exemplary embodiments. It is apparent to one skilled in the art, however, that the present invention can be practiced without these specific details or with an equivalent arrangement. In some instances, well-known structures and devices are shown in block diagram form in order to avoid unnecessarily obscuring the preferred embodiment.

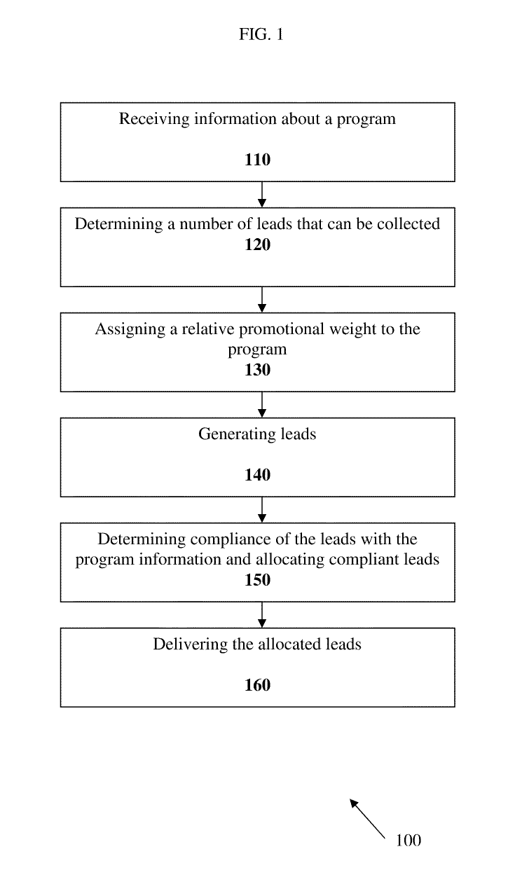

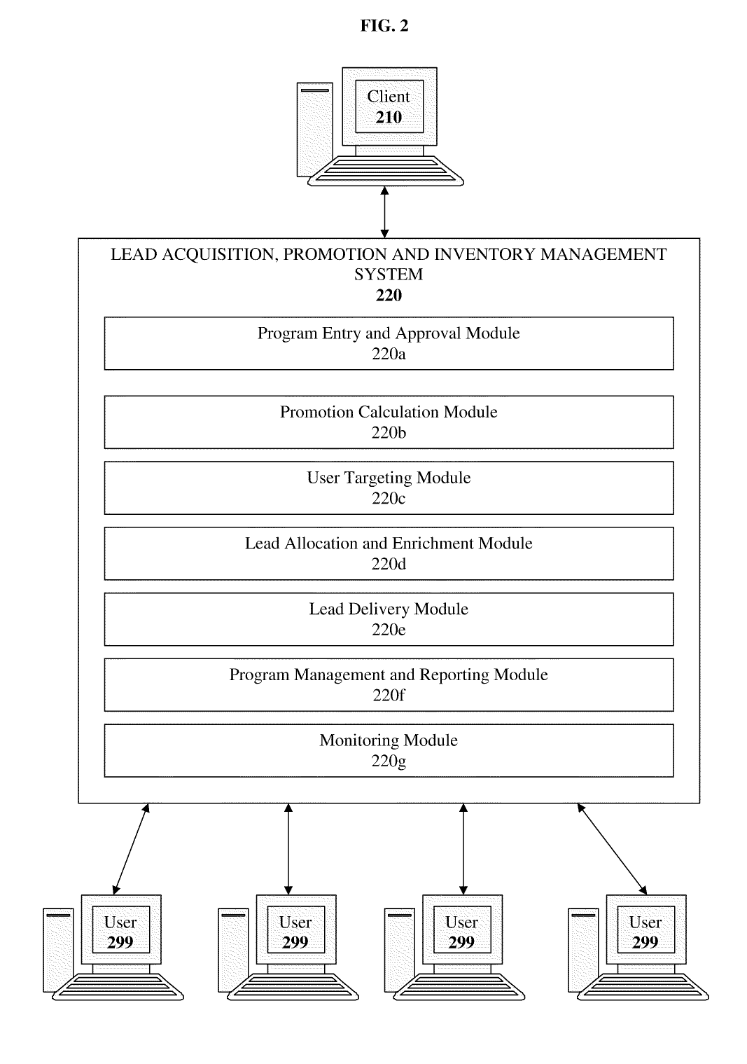

Referring now to the drawings, wherein like reference numerals designate identical or corresponding parts throughout the several views, FIG. 1 is a flowchart 100 illustrating a method for managing a lead acquisition advertising system according to one embodiment. At processing block 110, information about a program is received from a client, such as an advertiser. Specifically, the following types of information may be entered: qualified registration filters, the number of custom registration questions required, the topic of the vendor assets that are to be promoted, and/or the number of vendor assets available for promotion.

Qualified registration filters, such as geographic or job title restrictions, are the requirements that each user must meet in order to be considered an acceptable lead. Each additional filter received by the client will decrease the number of eligible users within a user database or site audience.

Custom registration questions are additional questions that a user is asked to answer at the time of registration. In general, the more questions that are asked, the lower the number of successful registration completions. Even adding a single question may be sufficient to reduce the percentage of successful registration completions.

Different topics may have different levels of user activity associated with them. Generally, it is easier to collect qualified registrations from users in a topic area where there is more activity or interest. The potential level of user interest in a particular program can also be determined by comparing the taxonomic nouns associated with a particular program with the population of users who have user profiles consisting of similar taxonomic nouns based on the content they have consumed. The number of leads that can be collected for a particular program can then be adjusted based on this demonstrated interest level.

In general, more vendor assets available for promotion will lead to more downloads by users. In addition, having multiple assets makes it less likely that a program will not collect sufficient registrations from users due to unattractive vendor assets.

Once this program information has been entered, a number of leads that can be collected based upon the program information is determined at processing block 120. This calculation depends upon the weighting given to the program information entered. The weightings may be based on, for example, historical experience with previous programs of the same type and topic. The resulting calculation may then be modified based on the current number of competing offers, historical delivery data, and/or available site traffic and newsletter capacity.

The ability to deliver registrations may be limited by the number of programs that are competing for the same pool of users within the same topic. The greater the number of competing programs within a topic, the less leads that can be delivered to each program.

Some types of programs, although within a popular topic that would normally attract a high number of users, may have delivered fewer leads than expected in past programs. This may be, for example, because a particular vendor dominates a particular topic area, or because the program has proven to be unpopular with a certain set of users. In these topic areas, the number of available leads may be reduced.

The ability to deliver registrations is dependent upon the promotional oppotunities available. Some topics may have less traffic, audience and newsletter subscriptions. In these cases, the number of available leads may also be reduced.

At this point, the client may be presented with the initial results of the calculations. If the client does not approve of the initial results, the client can explore different program scenarios by altering those factors that are variable to create a program that meets the client's needs. After acceptance of the calculations is received from the client, an order approval number may be generated.

At processing block 130, a relative promotional weight is assigned to the program in order to determine the amount of promotion that is given to each advertiser program within a pool of eligible users. Throughout the length of the program, the relative promotional weight may be adjusted on a periodic basis (for example, every 24 hours). This adjustment is based on the delivered registration information. The promotional weight may be based on the following factors: the remaining time the program will be active (measured in days), the required number of acquisitions remaining to be made, the amount of user engagements and the number of acquisitions that have been made since the program began, and/or that number of days required to collect the leads that have already been collected. In addition, the relative weightings may be adjusted manually.

At processing block 140, leads are generated by comparing programs to one or more user profiles, and selecting a program to offer based on the assigned relative promotional weight. This may be done once, or after each adjustment of the relative promotional weight of the program. The user profile may include any information that assists in targeting users as potential leads for the program, such as taxonomic nouns, user behavior characteristics, and/or demographic nouns.

One embodiment in accordance with the present invention includes identifying a document that a user browsed and parsing the document to identify and analyze discrete information items. The discrete information is then labeled and stored as taxonomic nouns. Taxonomic nouns are classifiable words used to help categorize documents and other content. The taxonomic nouns may be author-generated (i.e., the author of the document provides details regarding the form, structure, content, and function of the document), user-generated (i.e., a user-generated tag characterizing the document), search term-generated (i.e., the terms that resulted in the user accessing the document), access-generated (i.e., attributes assigned based on the manner in which the document was accessed), and/or topic-generated (i.e., significant topics or terms from the document). These taxonomic nouns are then used to select programs that match the user profile.

In another embodiment, user behavior characteristics indicative of actions taken by a user are accumulated, labeled, and stored. The user behavior characteristics can then be combined with the taxonomic nouns to be added to the user profile. In a further embodiment, user registration information can be labeled and stored as demographic nouns, and the user profile can be extended to include them in addition to the user behavior characteristics and the taxonomic nouns. After all available and/or selected user profile information has been collected, users that qualify for the program can be selected and identified as potential leads for that program. This method is described in greater detail in U.S. patent application Ser. No. 12/362,840, filed Jan. 30, 2009, the disclosure of which is hereby incorporated by reference in its entirety

At processing block 150, compliance of the one or more leads with the program information is determined by ensuring that the leads meet the advertiser criteria entered and the basic data integrity criteria for acceptance. If one or more of the leads are compliant, the compliant leads are allocated to a program as a successful acquisition. If one or more of the leads are not compliant, the non-compliant leads are de-allocated. If the lead is de-allocated, it may be enriched by comparing data points with data collected from third party data sources. If a sufficient match can be made with the third party data, the third party data is appended to the lead, and the lead is allocated to the appropriate program. In the event that the program is associated with a webcast, additional information related to webcast attendance is also imported and appended to the leads prior to allocation.

At processing block 160, the allocated leads are delivered to the client. The allocated leads may be delivered in a variety of ways. In one embodiment, the leads are delivered through a lead delivery file. In this method of delivery, a spreadsheet is prepared containing all the registration information that is to be delivered, and makes it available to an assigned account coordinator for review and downloading. In another embodiment, the leads are delivered to a third party computer readable medium or registration system. In this method of delivery, the registration information is delivered electronically without any human intervention.

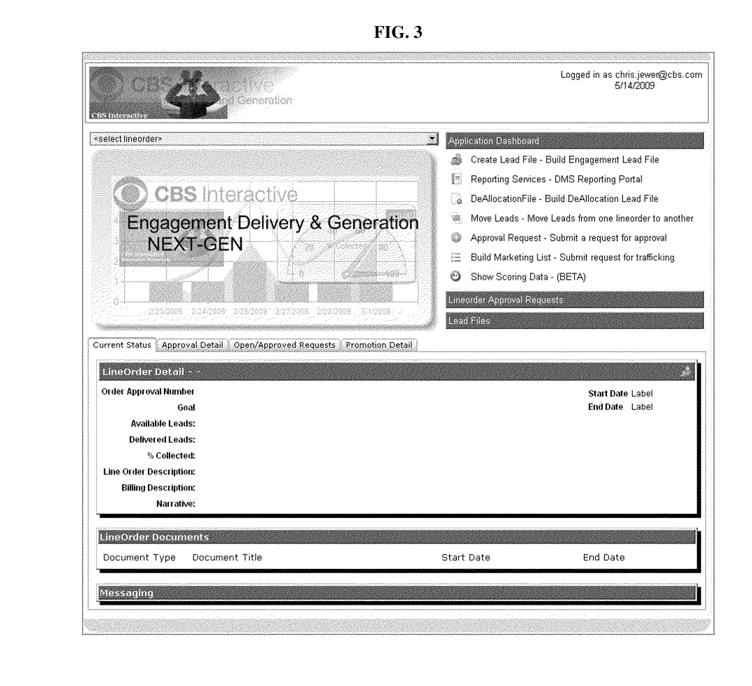

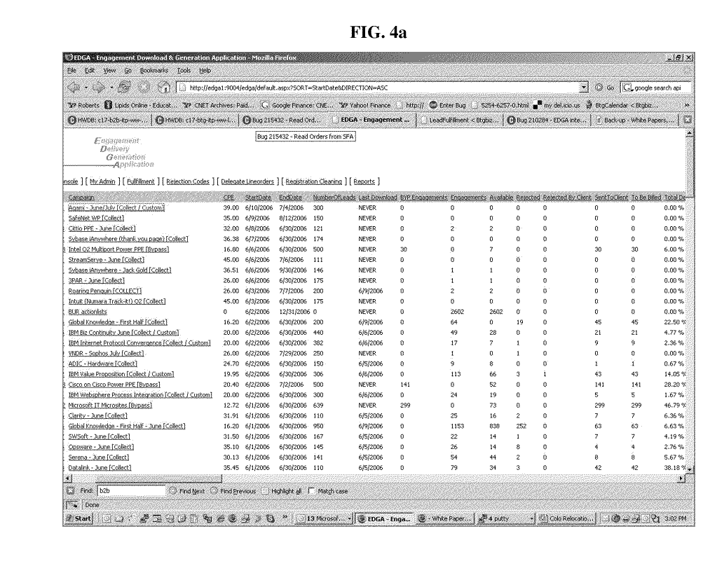

FIG. 2 is a diagram illustrating a lead acquisition, promotion and inventory management system according to one embodiment. Client 210 is connected, for example by a network, to lead acquisition, promotion and inventory management system (“LAPIM system”) 220. Client 210, such as an advertiser, begins by entering the details of a proposed program into a main client console screen, such as that shown in FIG. 3. Specifically, program entry and approval module 220a receives from the client information about qualified registration filters, the number of custom registration questions required, the topic of vendor assets that are to be promoted, and/or the number of vendor assets available for promotion, as described in further detail above. By analyzing this information, program entry and approval module 220a determines how many acquisitions can be made and what should be charged for each acquisition. These calculations depend upon the weighting given to the various information received from client 210. After analyzing client 210's program and determined that client 210's requirements have been met, program entry and approval module 220a generates an order approval number.

After an approval number has been generated by program entry and approval module 220a, promotion calculation module 220b calculates the level of promotion that a program needs relative to other competing programs within LAPIM system 220. The goal of these calculations is to ensure that revenue is maximized, and that all of client 210's goals are met. Additionally, promotion calculation module 220b is designed to deliver all acquisitions within seventy-five percent of the length of time the program is scheduled to run.

Promotion calculation module 220b fulfills these goals by assigning a relative promotional weight to each program that may be adjusted throughout the length of the program, as described above with respect to FIG. 1. Adjustments to the relative promotional weight are based on delivered registration information, such as the amount of user engagements and the number of acquisitions that have been made since the program's commencement, that have been imported from lead allocation and enrichment module 220d, as discussed below.

Once a relative promotional weight is assigned to the program, user targeting module 220c generates leads by comparing the assigned relative promotional weight to one or more user profiles. This may be done once, or after each adjustment of the relative promotional weight of the program. The user profile may include any information that assists in targeting users as potential leads for the program, such as taxonomic nouns, user behavior characteristics, and/or demographic nouns, as described in detail above. After all available and/or selected user profile information has been collected, users that qualify for the program can be selected and identified as leads for that program by user targeting module 220c.

For example, program entry and approval module 220a may determine that it can deliver 100 registrations over a program length of 10 days. Promotion calculation module 220b will assign a relative promotional weight designed to ensure that the 100 leads are delivered within the first 7 or 8 days the program is running. The program is then promoted, in competition with other programs, to a plurality of targeted eligible users 299 across various sites and newsletters using this assigned weight. At the end of the first day of promotion, lead allocation and enrichment module 220d may report that there has been a total of 40 engagements and 4 acquisitions. Based on this information, and the 9 days remaining in the program, the relative promotional weight is recalculated and fed to targeted eligible user pools, and the process begins again.

Lead allocation and enrichment module 220d analyzes the registrations acquired for each program to determine if they meet client 210's criteria entered in program entry and approval module 220a. It also checks that the registration meets basic data integrity criteria for acceptance. If the registration data meets those requirements, it is allocated to the program as a successful acquisition; if not, it is de-allocated, as described above. Lead allocation and enrichment module 220d may also be used to score leads.

Lead delivery module 220e delivers all the registration information that meets the requirements of the program to the customer, using either a lead delivery file or a third-party computer-readable medium or registration system, without any human intervention. In the case of lead delivery files, lead delivery module 220e has an interface which allows an account coordinator to review, and either accept or reject the allocated leads. Once the account coordinator has accepted the leads, he or she is able to download the spreadsheet file for delivery to client 210. Lead delivery module 220e also has interfaces for retrieving de-allocated leads for later delivery, for recording leads that are rejected by client 210, and for moving leads between different programs.

Program management and reporting module 220f reports on the performance of individual programs. In addition, it reports on the overall performance of all of the programs within LAPIM system 220. It records a large number of statistics about each program, including how many registrations have been delivered, which programs are at risk of not being fulfilled, and how much revenue is in danger of being lost.

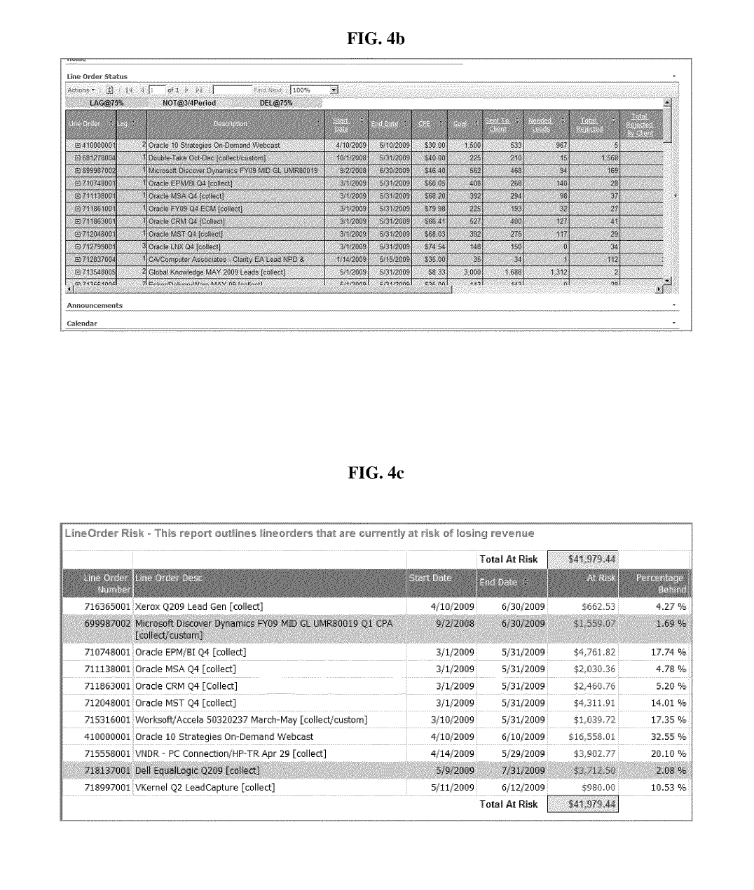

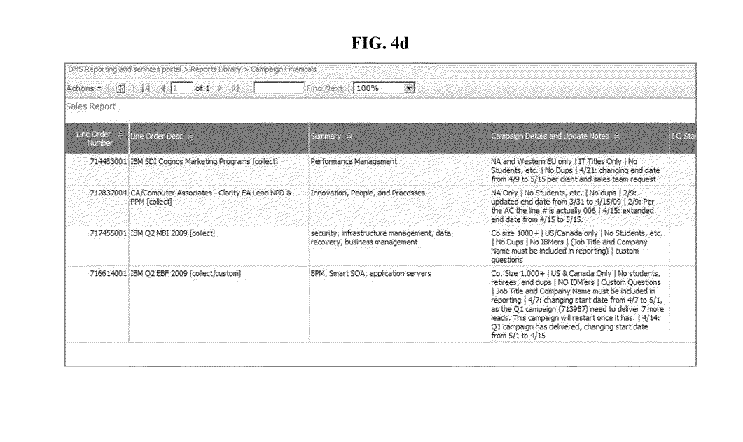

FIGS. 4a-4d illustrate examples of various reports that are available. FIG. 4a illustrates a complete program management screen for LAPIM system 220. FIG. 4b illustrates a program status report, showing delivery progress. FIG. 4c illustrates a program risk report showing risk of under-delivery. FIG. 4d illustrates a sales report showing program details. It should be appreciated that FIGS. 4a-4d are only exemplary in nature, and are not an exhaustive list of reports that may be available.

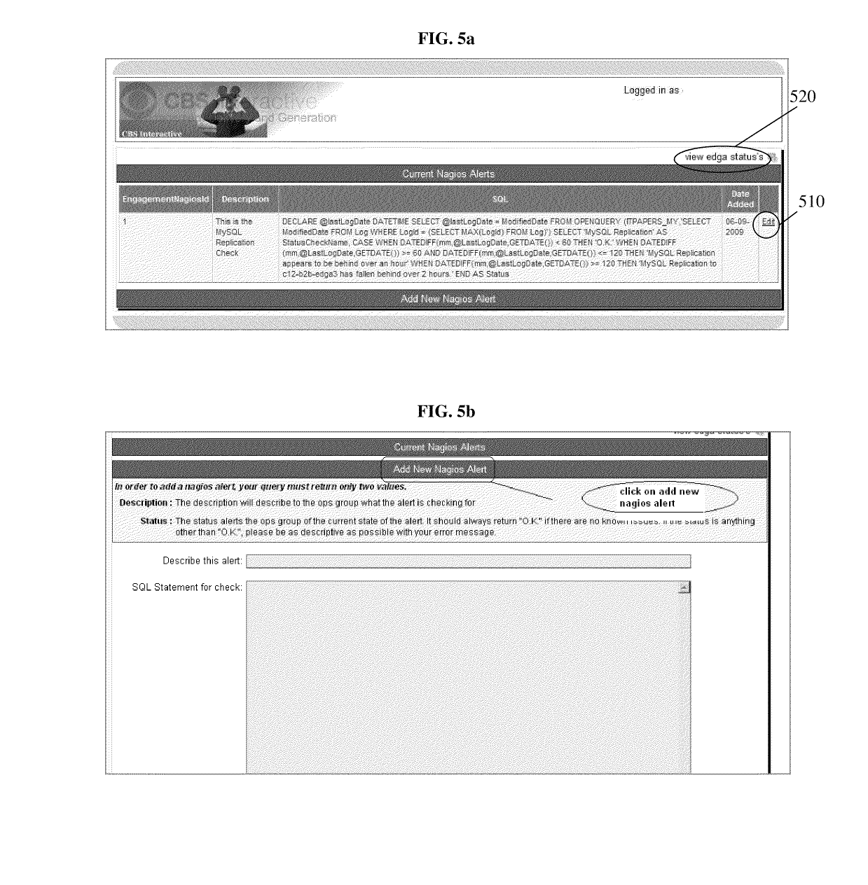

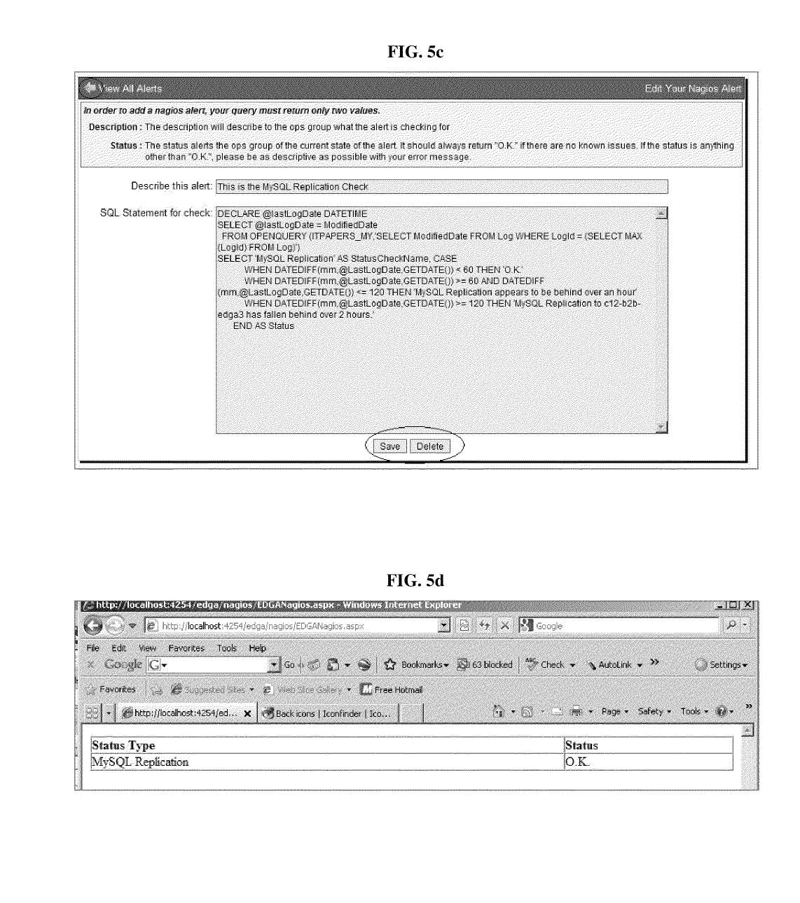

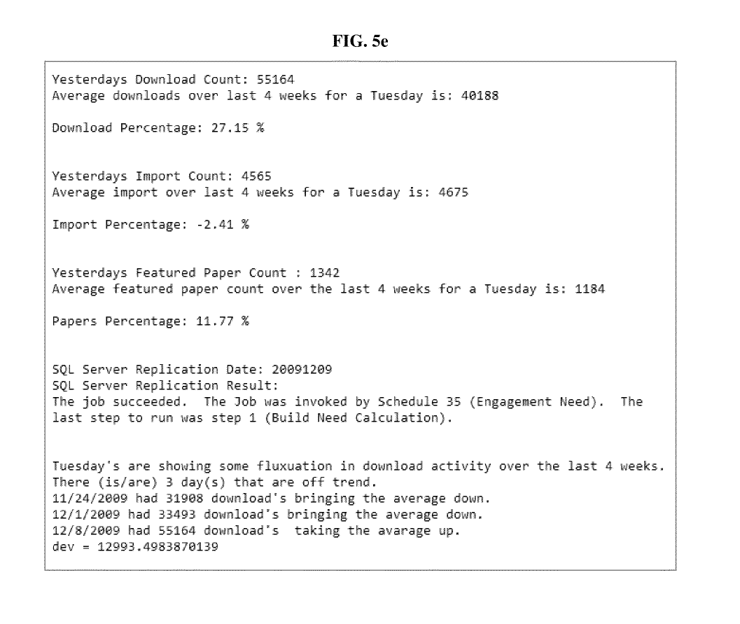

Monitoring module 220g integrates alerting into LAPIM system 220 through the use of an administration interface. Once an alert is entered into monitoring module 220g, an HTML report is created of the system status as described below with respect to FIG. 5a-e.

FIG. 5a illustrates the initial client interface, which displays alerts that are entered into monitoring module 220g. To add a new alert, client 210 can add a brief description of what he or she is looking for, such as in the alert setup screen shown in FIG. 5b. To edit an existing alert, client 210 can select “edit” option 510, shown in FIG. 5a. Client 210 will be navigated to a form allowing the edit to take place, such as the alert edit screen shown in FIG. 5c. This form allows the user to either delete the existing alert or edit its description. This form may also allow client 210 to navigate back to the initial client interface illustrated in FIG. 5a. To view the results of the input, client 210 can select option 520 in order to view the status of alert. An alert status screen, such as that shown in FIG. 5d, will be presented to client 210. In addition to these alerts, monitoring module 220g may also display and/or deliver a periodic report on previous acquisition activity. FIG. 5e illustrates an example daily report of the previous day's activity. The various reports and alerts within program management and reporting module 220f and monitoring module 220g are designed to allow easy monitoring of all modules within LAPIM system 220.

It should be noted that the modules as illustrated and discussed perform particular functions and interact with one another. It should be understood that these modules are merely segregated based on their function for the sake of description and represent computer hardware and/or executable software code which is stored on a computer-readable medium for execution on appropriate computing hardware. The various functions of the different modules and units can be combined or segregated as hardware and/or software stored on a computer-readable medium as above as modules in any manner, and can be used separately or in combination.

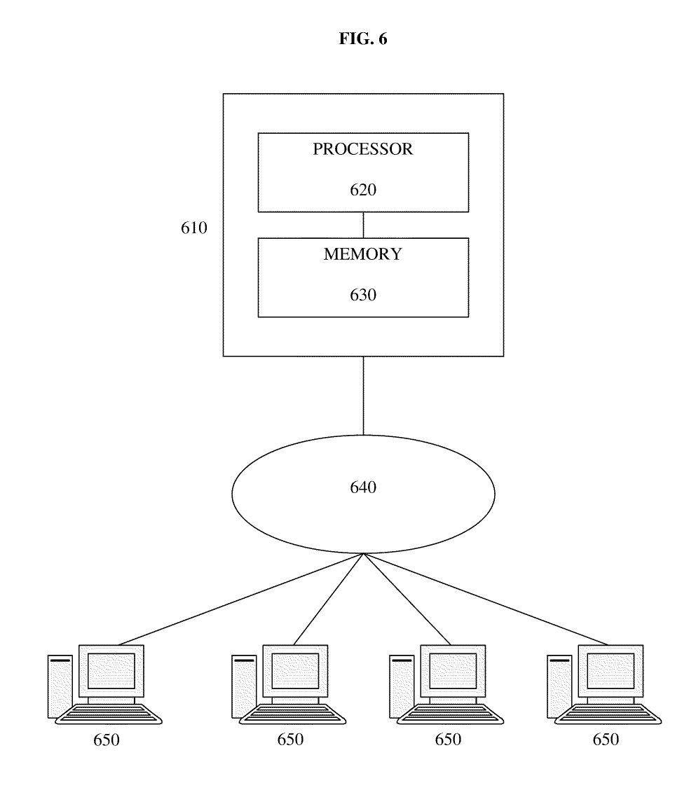

FIG. 6 illustrates a system of an embodiment for effecting the functions described above. Server 610 that is connected over network 640 to a plurality of user systems 650. Server 610 includes processor 620 and memory 630, which are in communication with one another. Server 610 is configured to deliver online content to users at the plurality of user systems 650. Server 610 is typically a computer system, and may be an HTTP (Hypertext Transfer Protocol) server, such as an Apache server. Server 610 may be built using a standard LAMP or other solution stack. Memory 630 may be any type of storage media that may be volatile or non-volatile memory that includes, for example, read-only memory (ROM), random access memory (RAM), magnetic disk storage media, optical storage media, flash memory devices, and zip drives. Network 640 may be a local area network (LAN), wide area network (WAN), a telephone network, such as the Public Switched Telephone Network (PSTN), an intranet, the Internet, or combinations thereof. The plurality of user systems 650 may be mainframes, minicomputers, personal computers, laptops, personal digital assistants (PDAs), cell phones, netbooks, thin clients, and other computing devices. The plurality of user systems 650 are characterized in that they are capable of being connected to network 640. The plurality of user systems 650 typically include web browsers.

In use, when a user of one of the plurality of user systems 650 wants to, for example, create a program as described above, a request to access content is communicated to server 610 over network 640. For example, a signal is transmitted from one of the user systems 650, the signal having a destination address (e.g., address representing the server), a request (e.g., content request), and a return address (e.g., address representing the user system that initiated the request). Processor 620 accesses memory 630 to provide the requested content, which is communicated to the user over network 640. For example, another signal may be transmitted that includes a destination address corresponding to the return address of the client system, and the content responsive to the request.

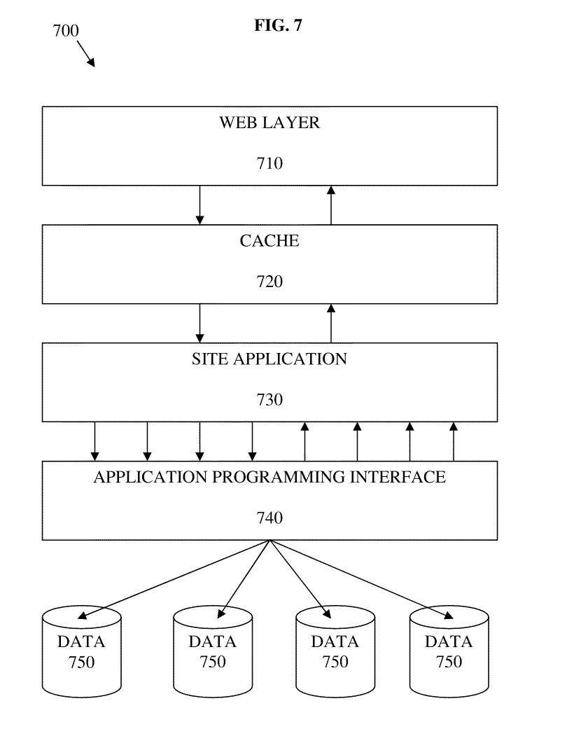

As shown in FIG. 7, system architecture 700 includes web layer 710, cache 720, site application 730, application programming interface 740, and a plurality of data stores 750. It will be appreciated that the system architecture may vary from the illustrated architecture. For example, web layer 710 may directly access data stores 750, the site application may directly access data stores 750, system architecture 700 may not include cache 720, etc., as will be appreciated by those skilled in the art. Web layer 710 is configured to receive user requests, for example, to create a program, through a web browser and return content that is responsive to the user request. Web layer 710 communicates the user requests to cache 720. Cache 720 is configured to temporarily store content that is accessed frequently by web layer 710 and can be rapidly accessed by web layer 710. In one embodiment, cache 720 may be a caching proxy server. Cache 720 communicates the user requests to site application 730.

Site application 730 is configured to update cache 720 and to process user requests received from web layer 719. Site application 730 may identify that the user request is for a page that includes data from multiple sources. Site application 730 can then convert the page request into a request for content from multiple sources and transmits these requests to application programming interface 740. Application programming interface 740 is configured to simultaneously access data from the plurality of data stores 750 to collect the data responsive to the plurality of requests from site application 730. The plurality of data stores 750 may include, for example, data about different characters, content to target to users, and the like. It will be appreciated that in alternative embodiments only one data store 750 may be provided to store the data.

The data in data stores 750 is provided to application programming interface 740, which provides the content to site application 730. Site application 730 updates cache 720 and delivers the cached content in combination with the accessed content to web layer 710, which delivers browsable content to the user, such as through a main client console screen, such as that shown in FIG. 3.

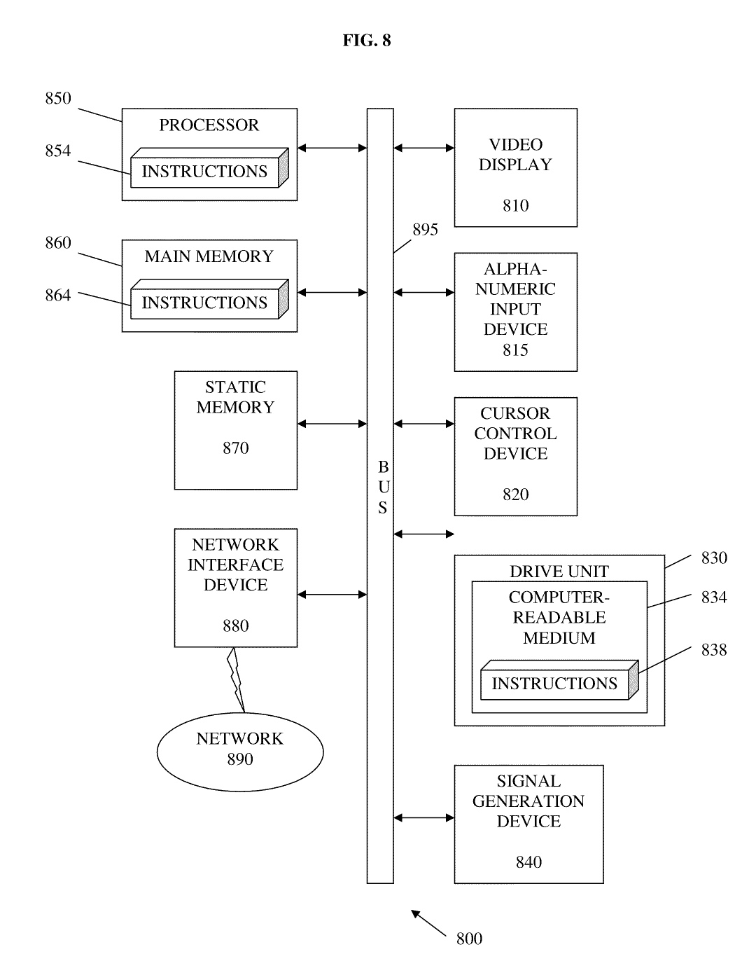

FIG. 8 shows a diagrammatic representation of a machine in the exemplary form of computer system 800 within which a set of instructions, for causing the machine to perform any one or more of the methodologies discussed herein, may be executed. In alternative embodiments, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

Computer system 800 includes processor 850 (e.g., a central processing unit (CPU), a graphics processing unit (GPU) or both), main memory 860 (e.g., read only memory (ROM), flash memory, dynamic random access memory (DRAM) such as synchronous DRAM (SDRAM) or Rambus DRAM (RDRAM), etc.) and static memory 870 (e.g., flash memory, static random access memory (SRAM), etc.), which communicate with each other via bus 595.

Computer system 800 may further include video display unit 810 (e.g., a liquid crystal display (LCD) or a cathode ray tube (CRT)). Computer system 800 also includes alphanumeric input device 815 (e.g., a keyboard), cursor control device 820 (e.g., a mouse), disk drive unit 830, signal generation device 840 (e.g., a speaker), and network interface device 880.

Disk drive unit 830 includes computer-readable medium 834 on which is stored one or more sets of instructions (e.g., software 838) embodying any one or more of the methodologies or functions described herein. Software 838 may also reside, completely or at least partially, within main memory 860 and/or within processor 850 during execution thereof by computer system 800, main memory 860 and processor 850 also constituting computer-readable media. Software 838 may further be transmitted or received over network 890 via network interface device 880.

While computer-readable medium 834 is shown in an exemplary embodiment to be a single medium, the term “computer-readable medium” should be taken to include a single medium or multiple media (e.g., a centralized or distributed database, and/or associated caches and servers) that store the one or more sets of instructions. The term “computer-readable medium” shall also be taken to include any medium that is capable of storing, encoding or carrying a set of instructions for execution by the machine and that cause the machine to perform any one or more of the methodologies of the present invention. The term “computer-readable medium” shall accordingly be taken to include, but not be limited to, solid-state memories, and optical and magnetic media.

It should be understood that processes and techniques described herein are not inherently related to any particular apparatus and may be implemented by any suitable combination of components. Further, various types of general purpose devices may be used in accordance with the teachings described herein. It may also prove advantageous to construct specialized apparatus to perform the method steps described herein. The present invention has been described in relation to particular examples, which are intended in all respects to be illustrative rather than restrictive. Those skilled in the art will appreciate that many different combinations of hardware, software, and firmware will be suitable for practicing the present invention.

The invention is achieved by manipulating data structures and transforming the data from one form, useable by a computer for one purpose, to another form, useable by a computer for another purpose.

Other implementations of the invention will be apparent to those skilled in the art from consideration of the specification and practice of the invention disclosed herein. Various aspects and/or components of the described embodiments may be used singly or in any combination. It is intended that the specification and examples be considered as exemplary only, with a true scope and spirit of the invention being indicated by the following claims.

What is claimed is:

1. A computer-implemented method for managing a lead acquisition advertising system, the method comprising:
receiving information about a program from a client;
determining a number of leads that can be collected based upon the program information;
assigning a relative promotional weight to the program;
generating leads by comparing program requirements to one of more user profiles, and selecting a program based on the assigned relative promotional weight, wherein at least one user profile includes taxonomic nouns identified from a document a user accessed;
determining compliance of the one or more leads with the program information, and if the leads are compliant, allocating the leads; and
delivering the allocated leads to the client.

2. The computer-implemented method of claim 1, wherein the program information includes one or more factors selected from the group consisting of qualified registration filters, custom registration questions, topic of vendor assets, and number of vendor assets available for promotion.

3. The computer-implemented method of claim 2, wherein the factors are weighted based on historical experience with other programs of at least one of the same type and the same topic.

4. The computer-implemented method of claim 1, further comprising modifying the number of leads based on one or more additional factors.

5. The computer-implemented method of claim 4, wherein the additional factors are selected from the group consisting of a current number of competing offers, historical delivery data, available site traffic, and newsletter capacity.

6. The computer-implemented method of claim 1, wherein the relative promotional weight is assigned based on at least one of remaining time the program is active, required number of leads remaining, number of user engagements since the program began, and required number of days to collect leads that have not previously been collected.

7. The computer-implemented method of claim 6, wherein the relative promotional weight is assigned periodically.

8. The computer-implemented method of claim 1, wherein the relative promotional weight is assigned manually.

9. The computer-implemented method of claim 1, wherein the program information includes advertiser criteria.

10. The computer-implemented method of claim 1, wherein the step of determining compliance of the one or more leads with the program information further includes analyzing the one or more leads to determine compliance with basic data integrity criteria.

11. The computer-implemented method of claim 1, further comprising de-allocating leads if they are not compliant.

12. The computer-implemented method of claim 11, further comprising:
comparing data points of the de-allocated leads with data collected by third-party data sources;
enriching the de-allocated leads with the third-party data; and
allocating the de-allocated leads.

13. The computer-implemented method of claim 1, further comprising:
determining performance of the allocated leads; and
reporting the performance to the client.

14. The computer-implemented method of claim 13, wherein the performance is determined based on at least one of how many leads have been delivered, which leads are at risk of not being fulfilled, and how much revenue is in danger of being lost.

15. The computer-implemented method of claim 13, further comprising creating one or more alerts based on the performance of the allocated leads.

16. The computer-implemented method of claim 1, wherein the one or more user profiles further includes user behavior characteristics indicative of actions taken by the user.

17. The computer-implemented method of claim 1, wherein the one or more user profiles further includes demographic nouns identified from user registration information.

18. The computer-implemented method of claim 1, wherein the taxonomic nouns are identified from at least one of author-generated tags, user-generated tags, search terms, access attributes, and significant topics, of the document.

19. The computer-implemented method of claim 18, wherein the access attributes include at least one of network type, referrer, and access time.

20. A lead acquisition advertising system, the system comprising:
a program entry and approval module configured to receive information about a program from a client and determine a number of leads that can be collected based upon the program information;
a promotion calculation module configured to assign a relative promotional weight to the program;
a user targeting module configured to generate leads by comparing program requirements to one or more user profiles, and selecting a program based on the assigned relative promotional weight, wherein at least one user profile includes taxonomic nouns identified from a document a user accessed;
a lead allocation and enrichment module configured to determine compliance of the one or more leads with the program information, and if the leads are compliant, allocating the leads; and
a lead delivery module configured to deliver allocated leads to the client.

21. The system of claim 20, wherein the program information includes one or more factors selected from the group consisting of qualified registration filters, custom registration questions, topic of vendor assets, and number of vendor assets available for promotion.

22. The system of claim 21, wherein the factors are weighted based on historical experience with other programs of at least one of the same type and the same topic.

23. The system of claim 20, wherein the promotion calculation module is further configured to modify the number of leads based on one or more additional factors.

24. The system of claim 23, wherein the additional factors are selected from the group consisting of a current number of competing offers, historical delivery data, available site traffic, and newsletter capacity.

25. The system of claim 20, wherein the relative promotional weight is assigned by the promotion calculation module based on at least one of remaining time the program is active, required number of leads remaining, number of user engagements since the program began, and required number of days to collect leads that have not previously been collected.

26. The system of claim 25, wherein the relative promotional weight is assigned periodically.

27. The system of claim 20, wherein the relative promotional weight is assigned manually.

28. The system of claim 20, wherein the program information includes advertiser criteria.

29. The system of claim 20, wherein the lead allocation and enrichment module is further configured to analyze the one or more leads to determine compliance with basic data integrity criteria.

30. The system of claim 20, wherein the lead allocation and enrichment module is further configured to de-allocate leads if they are not compliant.

31. The system of claim 30, wherein the lead allocation and enrichment module is further configured to:
compare data points of the de-allocated leads with data collected by third-party data sources;
enrich the de-allocated leads with the third-party data; and
allocate the de-allocated leads.

32. The system of claim 20, further comprising a program management and reporting module configured to determine performance of the allocated leads and report the performance to the client.

33. The system of claim 32, wherein the performance is determined based on at least one of how many leads have been delivered, which leads are at risk of not being fulfilled, and how much revenue is in danger of being lost.

34. The system of claim 32, further comprising a lead delivery monitoring module configured to create one or more alerts based on the performance of the allocated leads.

35. The system of claim 20, wherein the one or more user profiles further includes user behavior characteristics indicative of actions taken by the user.

36. The system of claim 20, wherein the one or more user profiles further includes demographic nouns identified from user registration information.

37. The system of claim 20, wherein the taxonomic nouns are identified from at least one of author-generated tags, user-generated tags, search terms, access attributes, and significant topics, of the document.

38. The system of claim 37, wherein the access attributes include at least one of network type, referrer, and access time.
